(19) United States
(12) Patent Application Publication
(10) Pub. No.: US 2001/0029646 A1
(43) Pub. Date: Oct. 18, 2001

(54) Fishing line securing device and a method of using the same

(76) Inventor: Samuel Wirtschfter, San Pedro, CA (US)

Correspondence Address: Daniel L. Dawes, MYERS, DAWES & ANDRAS LLP, Suite 1150, 19900 MacArthur Boulevard, Irvine, CA, 92612, US

(21) Appl. No.: 09/758,595

(22) Filed: Jan. 10, 2001

Related U.S. Application Data
(60) Provisional application No. 60/175,559, filed on Jan. 11, 2000.

(51) Int. Cl. F16G 11/00

(52) U.S. Cl. 24/130

(57) ABSTRACT

A fishing line securing device comprises a structure having a notched groove defined in a top portion thereof. The groove is shaped as two diagonally opposing slits dug into the top portion of the device. A pair of corresponding overhanging shoulders project toward each other above the slits to retain a fishing line. A raised central ridge also keeps the fishing line secured in the slit of the groove. The device comprises an adhesive bottom surface adapted to adhere to an outer flange of a fishing reel or any other component of a fishing rod. The securing device may also be used in a variety of other applications.

### RELATED APPLICATIONS

The present application is related to U.S. Provisional Patent Application, Ser. No. 60/175,559, filed on Jan. 11, 2000, which is incorporated herein by reference.

### BACKGROUND OF THE INVENTION

1. Field of the Invention

The invention relates generally to devices for securing a fishing line.

2. Description of the Prior Art

A fishing line can easily become unraveled from a fishing reel if it is not tightly secured. Though the prior art includes devices to secure a line against an object, a need still exists for a more convenient way of securing a fishing line.

Stein, “FISH LINE RESTRAINER”, U.S. Pat. No. 3,771,741 (1973), discloses a restrainer 40 which is attached to a bail 20 of the spinning reel 12. The restrainer 40 has a body 42 which includes an aperture 44 through which the line 46 is inserted. The line 46 is held in place by a threaded screw 48 which intersects the aperture 44 and contacts the line 46.

Gris, “SPINNING REEL LINE RETAINER”, U.S. Pat. No. 3,164,334 (1965), discloses a retainer 22 that includes a generally U-shaped member 24 defined by the legs 26 and 28 and an interconnecting bight portion 30. The legs 26, 28 are shaped to clamp onto the shank portion 18 of a fishing reel 12. The retainer 22 includes a spring 48 which has convolutions 52. The fishing line 16 is secured by wrapping it around the shank portion 18 and the spring 48. Thus, it appears that the convolutions 52 of the spring 48 clamp onto the line 16.

Stocchi, “ANCHORING DEVICE FOR SECURING AN END PIECE OF A CORD WOUND UP ONTO A STORAGE REEL”, U.S. Pat. No. 5,603,469 (1997), discloses a storage reel 2 having flanges 4. A W-shaped clip 8 is disposed on an outer surface 4b of the flange 4. The clip 8 has retaining loops 12 on one end and a counter loop 13 on an opposing end. The line 7 is secured against the outer surface 4b of the flange 4 by the retaining loops 12, which are prevented from moving away from the flange by the counter loop 13 acting against the flange 4.

Sanda et al., “METAL WIRE WINDING REEL”, U.S. Pat. No. 5,549,257 (1996), discloses a metal wire winding reel 40 having a clip 3 disposed on an inner surface of a flange 1. In FIG. 4, the end W₀ of the wire W is inserted in the clearance between the bent forward end 42 of the clip 3 and the outer peripheral edge 1 a of the flange 1. The wire W is then held by being pulled toward the center of the reel 40.

Place, “FASTENER”, U.S. Pat. No. 2,265,393 (1938), discloses a clip having a head 11 and a shank 12. The shank 12 includes two legs 12, 21 which are designed to be inserted into an opening 30, 31 of an object 29 against which the line 32, 33 is to be secured. In FIG. 1, the head 11 includes a U-shaped tongue 13. The tongue 13 is bent outward at the end 14 to allow a cable to pass through and at the mid-portion 15 to form a recess for receiving the cable 32, 33.

Therefore, what is needed is an improved device for securing a fishing line to a fishing rod or fishing reel as well as an improved device to secure any type of line to an object.

### BRIEF SUMMARY

A fishing line securing device comprises a disk-shaped body with a notched groove defined in a top portion. In profile, the notched groove is defined by a pair of curved shoulders which have been undercut to form two opposed symmetric, curved, downwardly angled slits between which is then defined in the groove a raised central ridge between the overhanging shoulders. The groove extends completely across a diameter of the body thereby being laterally open at the ends of the groove so that the groove is open at the sides of the body. The groove is also open and accessible from the top of the body, thus allowing a user to easily engage a line by simply placing a portion of the line adjacent to a terminal end into the groove and then pulling to secure the line into one of the slits of the groove by being wedged into the slit underneath the shoulder.

The body of the securing device is shaped like a button having a circular perimeter although other shapes can be equally substituted, such as any polygonal shape. The securing device may be integral with or separate from a fishing reel. The securing device may be retrofitted onto an existing fishing reel by coupling the bottom surface of the securing device to an outer surface of a flange of a fishing reel. The bottom surface may have an adhesive material to allow the securing device to be adhered to a fishing reel or other component of a fishing rod.

In summary, a fishing line securing device comprises a structure having a notched groove defined in a top portion thereof. The groove is shaped as two diagonally opposing slits defined by two corresponding angled slits defined into the top portion of the device. A raised central ridge also assists to keep the fishing line secured under one of the slits defining the groove. The device comprises an adhesive bottom surface adapted to adhere to an outer flange of a fishing reel or any other component of a fishing rod. The securing device may also be used in a variety of other applications.

The invention, now having been briefly summarized, may be better visualized by turning to the following drawings wherein like elements are referenced by like numerals.

### BRIEF DESCRIPTION OF THE DRAWINGS

FIG. 1 is a top plan view of the securing device;

FIG. 2 is an elevational side view of the securing device;

FIG. 3 is an operative top plan view of the securing device as applied to a fishing reel;

FIG. 4 is an elevational side view of the securing device and fishing reel in FIG. 3;

FIG. 5 is a cross sectional side view of the securing device taken along lines 5′-5′ of FIG. 3.

FIG. 6a is a perspective view of a second embodiment of the invention.

FIG. 6b is a top plan view of the second embodiment of FIG. 6a.

FIG. 6c is a end plan view of the second embodiment of FIG. 6a as seen through lines 6c-6c of FIG. 6b.

FIG. 6d is a end plan view of the second embodiment of FIG. 6a as seen through lines 6d-6d of FIG. 6b.

FIG. 6e is a cross sectional side view of the second embodiment of FIG. 6a as seen through lines 6e-6e of FIG. 6b.

FIG. 6f is a cross sectional side view of the second embodiment of FIG. 6a as seen through lines 6f-6f of FIG. 6b.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS

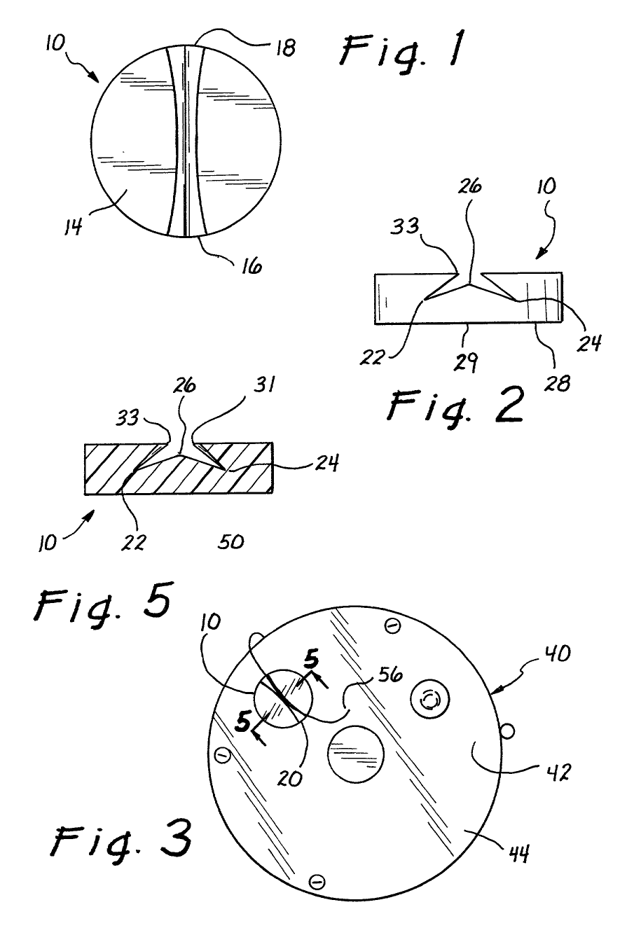

FIG. 1 is top plan view of the fishing line securing device 10. The device 10 has a top portion 14 and a circular perimeter 13, although any perimeter shape may be used. The device 10 comprises a rigid material, which includes metals, wood, and plastics. In the preferred embodiment, the device 10 comprises a plastic material. In the preferred embodiment, the device 10 has a 0.5 inch diameter “D”. A notched groove 20 is defined in the top portion 14 and extends through from a front end 16 to a back end 18. The groove 20 is open and accessible from the front end 16 and the back end 18. Furthermore, the groove 20 is open and accessible throughout its length from a top side or top angle.

FIG. 2 is an elevation view of the securing device 10. In the preferred embodiment, the securing device 10 has a height “H” of approximately 0.125 inch. The groove 20 is defined in the top portion 14 of the device 10 by a pair of opposing slits 22, 24. The slits 22, 24 are defined in the device 10 at a diagonal or inclined angle with respect to the plane of top portion 14 so as to form a central ridge 26. The central ridge 26 is shaped as a raised line by virtue of the slits 22, 24 being defined into the top portion 14 of the securing device 10 at an angle. The raised surface 26 helps to direct a line into either slits 22 or 24 as it is pulled across the groove and pulling downwardly. The lowermost apex of slits 22, 24 is acute or sharply terminated into a V-groove so that a fishing line can be mechanical jammed or compressed into the apex thereby fixing its position in device 10.

Overhanging shoulders 31, 33 are disposed over and define in part the slits 22, 24, respectively, to prevent the line from easily escaping. The shoulders 31, 33 point toward each other. The securing device 10 also has a bottom surface 28. An adhesive material 29 may be disposed on the bottom surface 28.

FIG. 3 is an operative end plan view of the securing device 10 coupled to an outer surface 42 of a flange 44 of a conventional fishing reel 40. The securing device 10 may be integral with or separate from the fishing reel 40. One advantage of the invention is that the securing device 10 may be retrofitted to an existing fishing reel to better secure a fishing line. In the preferred embodiment, this is accomplished simply by adhering the adhesive bottom surface 28 of the device 10 to the flange 44 of the fishing reel 40. Many other ways of coupling the securing device 10 to the fishing reel 40 may be employed including mechanical coupling by threading, screws, bolts and the like. Furthermore, the device 10 may be coupled to any other component of the fishing gear, including without limitation the rod itself.

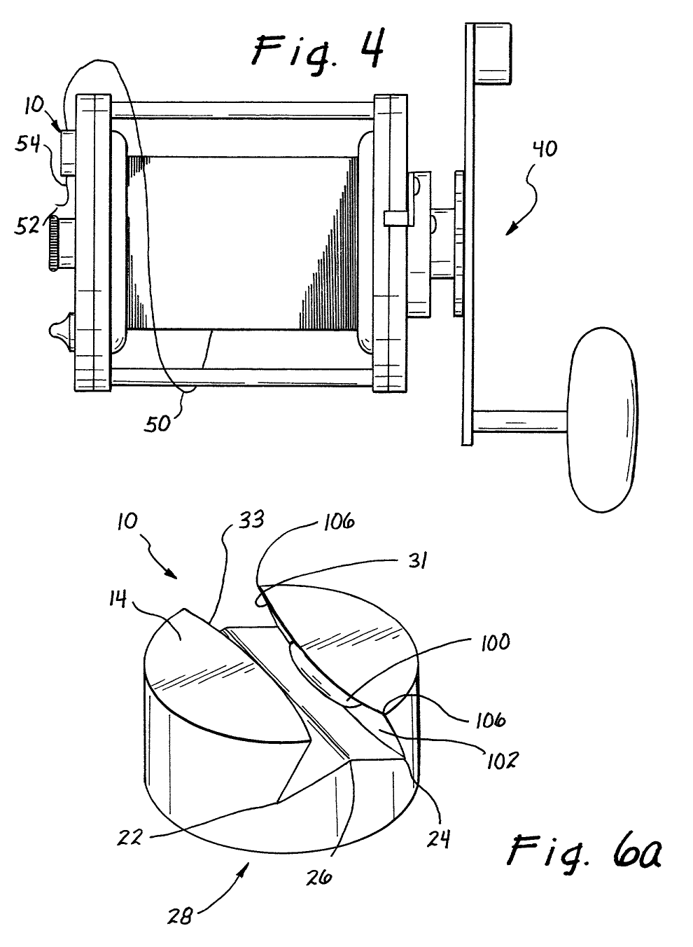

FIG. 4 is an elevation side view of the fishing reel 40 with the securing device 10 applied thereto. It will be appreciated that a fishing line 50 can be easily secured by the securing device 10 by placing a portion 54 of the line 50 adjacent to the terminal end 52 into the groove of the securing device.

FIG. 5 is a cross-sectional view of the securing device 10 taken along lines 5′-5′ of FIG. 3. The line 50 is disposed in one of the slits 24 and is held securely in place by virtue of compression by the overhanging shoulder 31 and the central ridge 26.

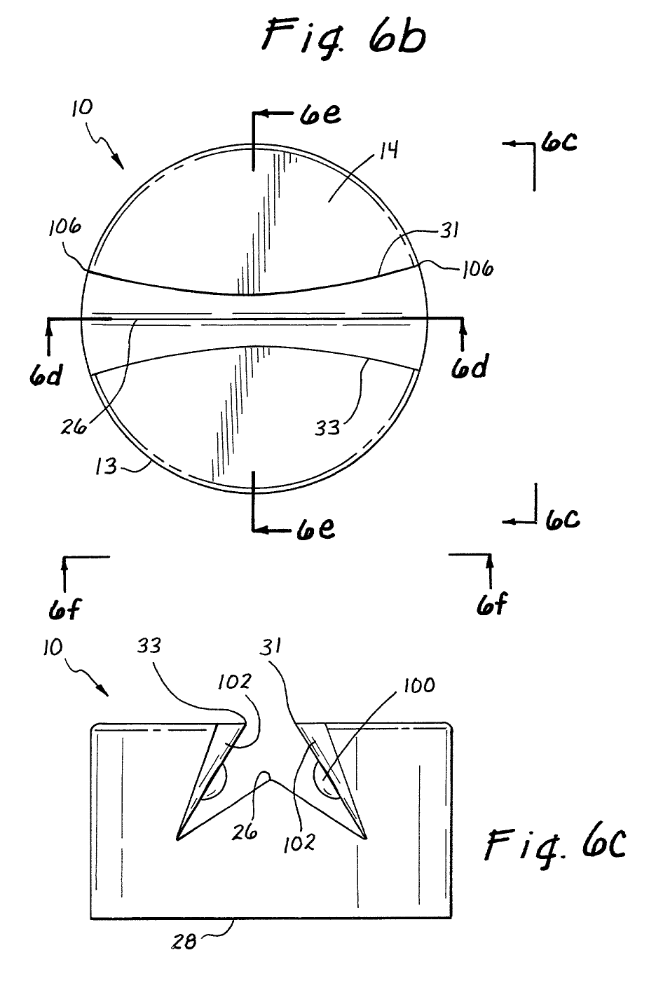

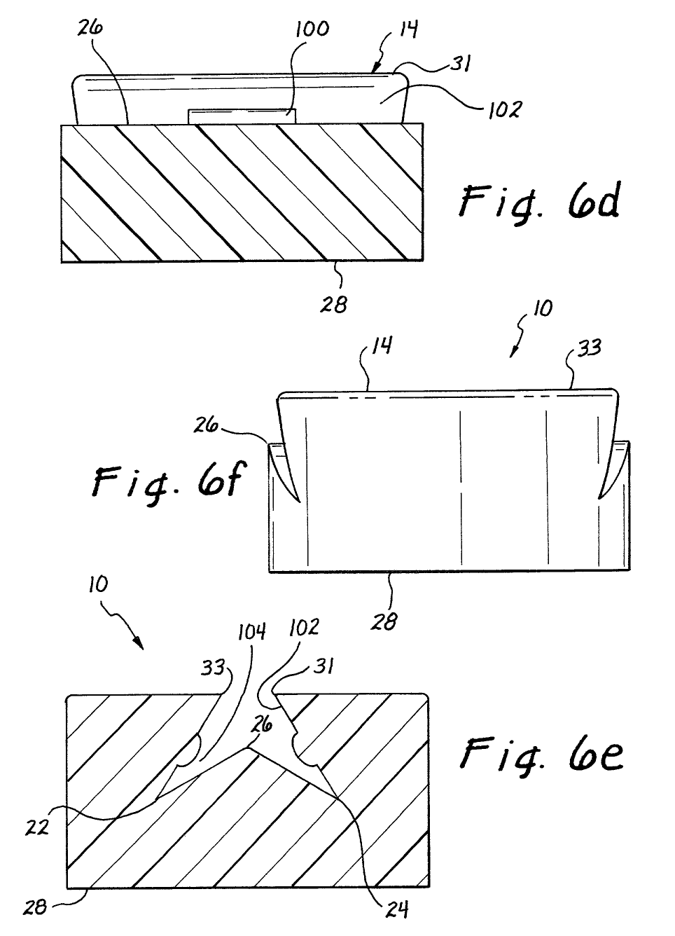

FIGS. 6a-6f depict a second embodiment of the invention. The second embodiment is identical to the first embodiment described above with the addition of two opposing bosses 100 best seen in the cross sectional view of FIG. 6e and in the end plan view of FIG. 6c. Boss 100 is defined approximately half way up the interior surface 102 of each shoulder 31. As best seen in FIG. 6f, boss 100 has its centerline or plane of symmetry 104 disposed below ridge 26 when viewed from an angle parallel to the planar aspect of the disk-shaped body. As seen in FIG. 6f boss 100 is centrally located on surface 102 with respect to ends 106 of shoulder 31. Boss 100 has a length parallel to the direction of slit 24 and extends across approximately the middle third of slit 24. Thus, boss 100 extends or protrudes into the space of slit 24 toward the sloping interior surface 108 extending between ridge 26 and the apex of slit 24 as seen in FIG. 6e. Boss 100 thus serves to provide a tactile feedback to the user as the fishing line 50 slides over boss 100 to indicate that the line 50 is disposed into the lower half of slit 24 through the entire length of slit 24, since line 50 tends to first catch or be seized by slit 24 at its ends 106. Boss 100 also serves as a means of retaining line 50 in slit 24.

It is to be expressly understood that though the preferred embodiment shown in the Figures comprises two slits 22, 24 and, thus, two corresponding overhanging shoulders 31, 33, the securing device 10 may simply comprise one slit and one corresponding overhanging shoulder. Still further, multiple slits may be provided in an intersecting pattern. For example, three slits with a form similar to that described above may be defined into a body in a “Y” pattern.

Furthermore, it is to be expressly understood that the device 10 may comprise applications beyond merely securing a fishing line to a fishing rod or reel. Applications comprise securing any type of line to an object. For example, device 10 may be appropriate modified to secure rope or line for halyards on boats, flagpoles, window blinds and wherever a line needs to be quickly and temporarily secured.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention which could be more broadly or narrowly defined later by patent claims.

The words used in this specification to describe the invention, and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in later in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in later defined claims or that a single element may be substituted for two or more elements in later defined claims.

Insubstantial changes from the claimed subject matter as viewed by a person with ordinary skill in the art, now known or later devised, are expressly contemplated as being equivalently within the scope of the invention. Therefore, obvious substitutions now or later known to one with ordinary skill in the art are defined to be within the scope of the defined elements.

The invention is thus to be understood to include what is specifically illustrated and described above, what is conceptionally equivalent, what can be obviously substituted and also what essentially incorporates the essential idea of the invention.

I claim:

1. An apparatus for securing a fishing line comprising:
a body; and
a groove defined in said body to define at least one shoulder having an undercut adapted for receiving and securing said fishing line.

2. The apparatus of claim 1 wherein said body is a circular disk.

3. The apparatus of claim 1 wherein said body has an upper surface and wherein said groove is open along at least part of said upper surface.

4. The apparatus of claim 3 wherein said groove is open and extends across said entire upper surface.

5. The apparatus of claim 4 wherein said body is a circular disk with a diameter and said groove is defined along said diameter of said circular disk.

6. The apparatus of claim 1 wherein said body is a polygonal shape.

7. The apparatus of claim 1 wherein said groove has a bottom and wherein said undercut defines a V-shaped notch defined into an edge in said bottom, said V-shaped notch adapted to compress said fishing line when said line is pulled into said V-shaped notch under tension.

8. The apparatus of claim 1 wherein said groove has two opposing shoulders.

9. The apparatus of claim 8 wherein said two opposing shoulders are symmetric with respect to each other.

10. The apparatus of claim 1 wherein said groove is defined by two opposing V -shaped cuts into said body.

11. The apparatus of claim 10 wherein said body has a planar aspect and wherein said two opposing V -shaped cuts are curved laterally across said planar aspect of said body.

12. The apparatus of claim 11 wherein said laterally curved cuts define widened opening at opposing ends of said cuts to facilitate access of said fishing line into said groove.

13. The apparatus of claim 10 wherein said two opposing V-shaped cuts are angled away from each other when viewed through a perpendicular cross section taken through said two opposing V -shaped cuts.

14. The apparatus of claim 1 further comprising a fishing reel and wherein said body is attached to said fishing reel.

15. The apparatus of claim 14 wherein said fishing reel has a side surface and where said body is adhered to said side surface.

16. A device for securing a fishing line comprising:
a structure with a top portion and having a notched groove defined in said top portion thereof, said notched groove being defined by two corresponding angled slits defined into the top portion; and
a raised central ridge defined in said notched groove between said corresponding angled slits to also assists to keep said fishing line secured under one of said slits defining said groove.

17. The device of claim 16 further comprising a fishing reel having an outer flange and an adhesive bottom surface adapted to adhere to said outer flange.

18. The device of claim 16 further comprising a fishing reel having an outer flange and wherein said structure is integral with said fishing reel.

19. A method for securing a fishing line device comprising:
disposing said fishing line into a notched groove defined in a top portion of a disk-shaped body in which said notched groove is defined by a pair of curved overhanging shoulders which have been undercut to form two opposed symmetric, curved, downwardly angled slits between which is then defined in said notched groove a raised central ridge between the overhanging shoulders, said groove extending completely across a diameter of said body thereby being laterally open at at least one end of said groove so that the groove is open at at least one side of said body, said groove being open and accessible from the top of the body;
placing a portion of said fishing line adjacent to a terminal end into said groove; and
pulling said fishing line to secure said line into one of said slits of said groove by being wedged into the slit underneath said overhanging shoulder.

20. The apparatus of claim 1 wherein said shoulder has an interior surface and further comprising at least one boss defined on said interior surface of said shoulder and extending into said groove.
